(19) United States
(12) Patent Application Publication
(10) Pub. No.: US 2003/0178869 A1
(43) Pub. Date: Sep. 25, 2003

(54) Collapsible, interior cargo compartment protective liner

(76) Inventor: Scott Edward Adams, Fallston, MD (US)

Correspondence Address: Royal W. Craig, Law Offices of Royal W. Craig, Suite 153, 10 N. Calvert Street, Baltimore, MD, 21202, US

(21) Appl. No.: 10/400,291

(22) Filed: Mar. 25, 2003

Related U.S. Application Data
(60) Provisional application No. 60/367,626, filed on Mar. 25, 2002.

(51) Int. Cl. B60R 13/01

(52) U.S. Cl. 296/39.1

(57) ABSTRACT

Disclosed herein is a cargo compartment protective liner utilized to eliminate damage to a vehicle's interior when hauling potentially messy cargo such as leaves, construction materials, or animals. The fully enclosed liner apparatus requires no modification to a vehicle to facilitate its use. The present invention generally comprises a collapsible, rigid frame designed to support six flexible panels that retain any dirt, debris, animal hair, etc., placed therein. One or more of the side or end panels may be opened to facilitate the loading and unloading of the apparatus. The flexible side and end panels are generally opaque, but two or more may be transparent to provide the driver with the sight lines required to safely operate the vehicle in which a liner apparatus has been installed. The liner apparatus is fully collapsible for ease of storage when not in use. The cargo area protective liner of the present invention is fabricated of a variety of strong, lightweight materials to provide the durability and portability required by the nature of its usage. The present invention's design is simple and straightforward, and can be economically manufactured.

### CROSS-REFERENCE TO RELATED APPLICATIONS

The present application derives priority from U.S. Provisional Patent Application No. 60/367,626 for “COLLAPSIBLE INTERIOR CARGO COMPARTMENT PROTECTIVE LINER”; Filed: Mar. 25, 2002.

### BACKGROUND OF THE INVENTION

1. Field of the Invention

The present invention relates to automotive accessories and, more particularly, to devices utilized to protect the interior of a minivan, a sport utility vehicle (SUV), and the like from being soiled or damaged by materials carried in the cargo compartment.

2. Description of the Background

Typically, an individual's, or family's finances do not allow for the purchase of multiple, limited use vehicles (e.g. traditional pickup trucks designed to efficiently haul cargo, but not people, or traditional two- or four-door sedans designed to efficiently accommodate people, but not cargo). Therefore, many of the most popular vehicles available in today's automotive marketplace are designed to be multi-purpose. The purchase of a multi-purpose vehicle, such as a minivan, a SUV, or the like, allows that individual/family to maximize the usefulness, or utility, of that single vehicle. A typical multi-purpose vehicle possesses a flexibly configured (e.g. removable seating surfaces) internal compartment providing the ability to transport people or various types of cargo in an equally effective manner. However, while even the transportation of people contributes to the wear and tear experienced by the interior of a vehicle, the hauling of various types of cargo often has a significantly greater detrimental effect. Particulate matter (e.g. dirt) and/or stains associated with cargo can permeate the vehicle's interior compartment and be difficult to remove (i.e. cause semi-permanent or permanent physical damage such as scratches/gouges/discolorization), thereby contributing to a rapid decline in the vehicle's resale or trade-in value

The present inventor is not the first to address the issue of protecting the cargo compartment of a vehicle with a liner. A search of the prior art reveals a number of five- and six-sided liner concepts. Five-sided (i.e. open at the top) liner variations can be found in U.S. Pat. No. 4,765,671 to Allen, U.S. Pat. No. 5,110,171 to Anthony, U.S. Pat. No. 5,419,602 to VanHoose, U.S. Pat. No. 5,927,785 to Cantrell, U.S. Pat. No. 6,017,074 to Biskup, U.S. Pat. No. 6,120,078 to Smyl, and U.S. Pat. No. 6,206,443 to Konop et al. For use strictly in enclosed vehicles (e.g. minivans, SUVs, station wagons), a few six-sided, or fully enclosed liners have been patented.

One variation on the six-sided theme is found in U.S. Pat. No. 4,877,281 to Altmann that discloses a protective liner for covering the interior surface of the cargo area of a vehicle. The liner covers the floor, walls, and ceiling of the vehicle's cargo area. An opening is provided to allow access to the interior of the liner. The interior framework of the vehicle supports the erected liner. Fasteners attached to the interior surfaces of the vehicle are attached to corresponding fasteners on the liner. In use the device protects all interior surfaces of the vehicle cargo area from soiling and unfavorable odors.

A second six-sided apparatus is found in U.S. Pat. No. 6,142,550 to Blyth, et al. The patent discloses a van liner used to insulate the cargo area of a transport van. The liner is molded from sections of glass reinforced plastics that when locked together form a completely sealed enclosure. The unit comprises a roof panel, a floor panel, side walls, forward wall panel, and rear wall panel. The liner is assembled/disassembled for use/storage and is transferable between vehicle models.

Yet another fully enclosed apparatus is found in U.S. Pat. No. 6,203,089 to Doolittle, III et al. which discloses a bag-like protective liner for use with vehicles possessing either a rear hatch or rear opening doors. It attaches to the opening of the rear hatch/doors and is tailored to the interior dimensions of the vehicle's cargo area. In use (i.e. the hauling of lumber, gravel, debris, etc.) the bag protects all surfaces of the cargo area including the floor, ceiling, front wall rear wall and sidewalls.

Unfortunately, each of the prior, six-sided or fully enclosed apparatus falls short of the optimum configuration for an interior compartment protective liner. The Altmann and Doolittle, III et al. apparatus require the installation of liner support means on either the interior surfaces or the cargo compartment opening of the vehicle. The Blyth et al. liner is a multi-component assembly requiring a certain minimum degree of knowledge and skill to install in an efficient and timely manner.

Therefore, there remains a need for an improved liner apparatus that provides a substantial degree of utility in protecting the internal compartment of multi-purpose vehicles from any cargo transported therein. An apparatus of this type should be simple to set-up/install, self-supporting to avoid the need to modify the vehicle(s) in any way (i.e. installation of support means), collapsible to allow for ease of storage, lightweight for optimum portability, and economical to manufacture to provide for widespread use.

### SUMMARY OF THE INVENTION

It is, therefore, the primary object of the present invention to provide an improved liner apparatus for protecting the interior cargo compartment of a minivan, a SUV, and the like from any cargo carried therein.

It is another object of the present invention to provide an improved liner apparatus for protecting the interior cargo compartment of a minivan, a SUV, and the like that increases the overall utility of the vehicle to its owner while preventing interior damage detrimental to its resale or trade-in value.

Yet another object of the present invention is to provide an improved liner apparatus for protecting the interior cargo compartment of a minivan, a SUV, and the like that is self-supporting and simple to set-up/install.

It is still another object of the present invention to provide an improved liner apparatus for protecting the interior cargo compartment of a minivan, a SUV, and the like that is collapsible to facilitate ease of storage.

It is another object of the present invention to provide an improved liner apparatus for protecting the interior cargo compartment of a minivan, a SUV, and the like that maximizes rearward visibility for the vehicle operator.

It is another object of the present invention to provide an improved liner apparatus for protecting the interior cargo compartment of a minivan, a SUV, and the like that is lightweight for portability.

Still another object of the present invention is to provide an improved liner apparatus for protecting the interior cargo compartment of a minivan, a SUV, and the like that is economical to manufacture.

These and other objects are accomplished by a cargo compartment protective liner utilized to eliminate damage to a vehicle's interior when hauling potentially messy cargo such as leaves, construction materials, or animals. The fully enclosed liner apparatus requires no modification whatsoever to a vehicle to facilitate its use. The present invention generally comprises a collapsible, rigid/semi-rigid frame designed to support six flexible panels that retain any dirt, debris, animal hair, etc., placed therein. One or more of the side panels may be opened to facilitate the loading and unloading of the apparatus. The flexible side and end panels are generally opaque, but two or more may be transparent to provide the driver with the sight lines required to safely operate the vehicle in which a liner apparatus has been installed.

The dimensions of a particular liner apparatus may be varied to suit a wide range of vehicle applications and configurations. For example, minivans are typically equipped with removable seats to allow users to significantly vary the volume of cargo that may be transported. The dimensions, or volume, of the present invention may be varied (i.e. expanded or contracted) to accommodate any interior configuration of the user's vehicle. The liner apparatus is fully collapsible for ease of storage when not in use. The cargo area protective liner of the present invention is fabricated of a variety of strong, lightweight materials to provide the durability and portability required by the nature of its usage. The present invention's design is simple and straightforward, and can be economically manufactured.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a side perspective view of a cargo compartment protective liner 20 according to a first embodiment of the present invention.

FIG. 2 is an end perspective view of the cargo compartment protective liner 20, as in FIG. 1.

FIG. 3 is an isometric perspective view of the cargo compartment protective liner 20 as in FIGS. 1 and 2, showing an end panel 50 in the open position for loading/unloading.

FIG. 4 shows the cargo compartment protective liner 20 as configured for use in a vehicle 80 containing a front row 82 of seats and a second seating surface 84.

FIG. 5 shows the cargo compartment protective liner 20 as configured for use in a vehicle 80 containing only a front row 82 of seats (i.e. the vehicle 80 as in FIG. 4 after the removal of the second seating surface 84).

FIGS. 6 and 7 collectively illustrate a perspective view of a cargo compartment protective liner 120 according to an alternative embodiment of the present invention. FIG. 6 is the unitary fabric liner, and FIG. 7 shows the frame 130.

FIG. 8 is a composite drawing of a top view (at position A), left side view (at position B), front view (at position C), and right side view (at position D) of an exemplary interlocking hinge of the scissors-configured support members 132 as in FIG. 7.

### DETAILED DESCRIPTION OF THE PREFERRED EMBODIMENTS

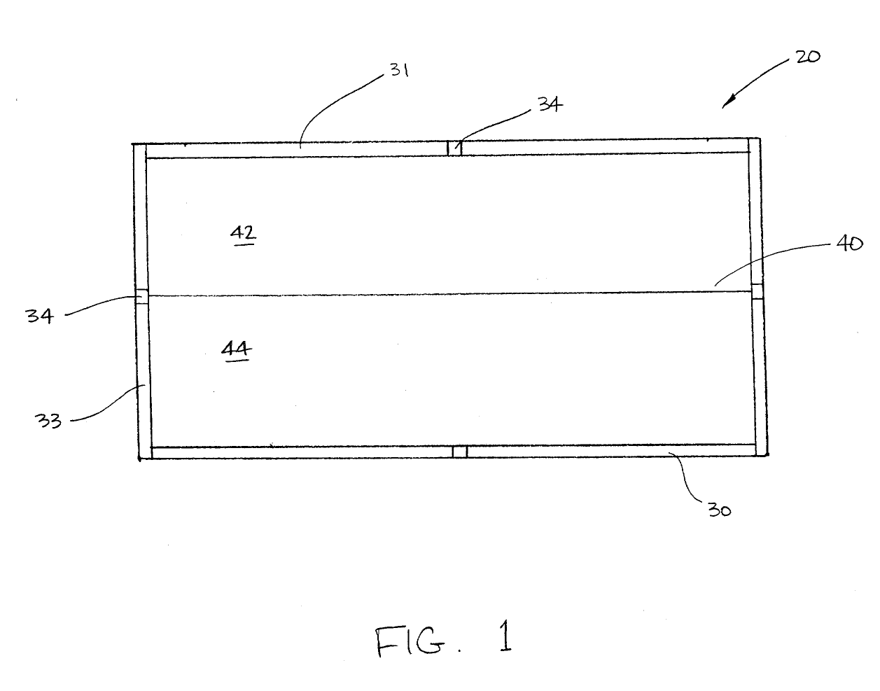

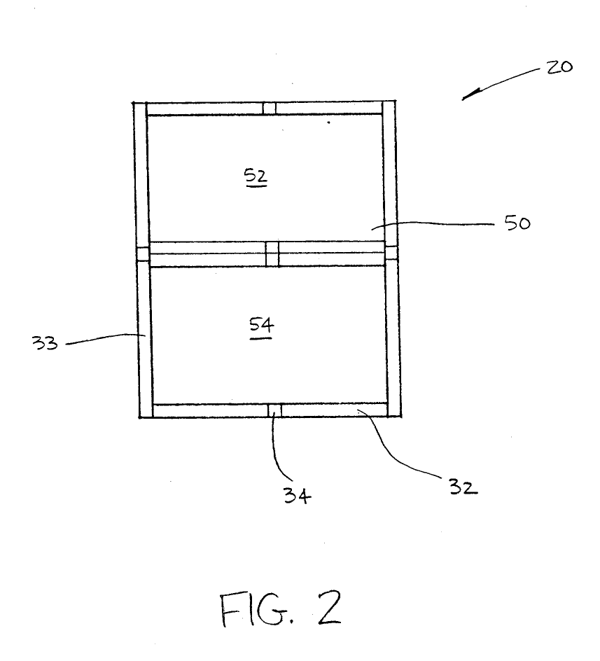

FIGS. 1-3 are, respectively, side, end, and isometric perspective views of a collapsible cargo compartment protective liner 20 according to a first embodiment of the present invention. The collapsible cargo compartment protective liner 20 generally comprises a collapsible, rigid frame 30 that supports flexible side panels 40, flexible end panels 50, a flexible top panel 60, and a flexible bottom panel 70. The six-sided, fully enclosed configuration of the liner 20 effectively isolates the cargo contained therein from the interior compartment of the vehicle in which it is installed.

The frame 30 includes long horizontal support members 31, short horizontal support members 32, and vertical support members 33. Each support member 31, 32, 33 is preferably fabricated of a rigid, lightweight, commercially available metal (e.g. aluminum) or plastic (e.g fiberglass, PVC) and typically incorporates a telescoping design to provide for the adjustment of its length. Locking devices 34 located on the support members 31, 32, 33 may be engaged to maintain each member 31, 32, 33 at the appropriate length. The support members 31, 32, 33 may be detachably attached at right angles in order to establish the erect, three-dimensional form of the liner 20. Alternatively, the support members 31, 32, 33 may be pivotally attached (e.g. 10 hinges with locking capabilities) to create a collapsible frame configuration. In its erect form, the frame 30 is self-supporting—there is no need to derive any additional support for the liner 20 via one or more connections to the interior compartment of a vehicle.

In yet another alternative embodiment of the present invention, certain support members (i.e. the vertical support members 33, and in some instances the short horizontal support members 32) may be spring-loaded to more completely utilize the vehicle's available cargo volume by extending to contact appropriate, or available, interior surfaces. Thereby automatically establishing the maximum possible length of each support member and the maximum possible volume for the liner 20.

The side panels 40 are slidably attached to the long horizontal support members 31 and the vertical support members 33. The end panels 50 are slidably attached to the short horizontal support members 32 and the vertical support members 33. The configurations of the side and end panels 40, 50 provide for their expansion or contraction to match the lengths of the support members 31, 32, 33.

The side panels 40 and the end panels 50 are generally opaque, but portions of two or more may be transparent to provide the driver with the rearward sight lines required to safely operate a vehicle in which a liner 20 is installed. When sight lines through the upper part of the liner 20 are required, the upper sections 42, 52 of the side and end panels 40, 50 may be fabricated of commercially available mesh-like or transparent plastic materials. The opaque, lower sections 44, 54 may be fabricated of commercially available materials such as nylon or canvas. When a mesh-like material is utilized for the upper panel sections 42, 52 and rearward sight lines are not required, opaque panels/flaps (not shown in the Figures) may be provided to cover the mesh panel sections to more completely retain the cargo held within the liner 20. The materials utilized for the side and end panels 40, 50 are lightweight, durable, impervious to liquids, and easy to clean. Alternatively, the materials may also possess a degree of elasticity in order to maximize the volume of cargo that may be loaded into the liner 20 (i.e. to extend beyond the dimensions of the support members 31, 32, 33 to more completely fill the available cargo volume within the vehicle).

The top panel 60 and the bottom panel 70 are slidably attached to the long horizontal support members 31 and the short horizontal support members 32. The configurations of the top and bottom panels 60, 70 provide for their expansion or contraction to match the lengths of the horizontal support members 31, 32. The top panel 60 and bottom panel 70 are generally fabricated of the same commercially available materials as those utilized for the opaque, lower sections 44, 54 of the side and end panels 40, 50.

Alternative embodiments of the present invention incorporate panels 40, 50, 60, 70 that, in addition to being slidably attached, are removably attached to the various support members 31, 32, 33. Moreover, the panels 40, 50, 60, 70 may be removably attached along either the inside or outside of the frame 30 and its various support members 31, 32, 33.

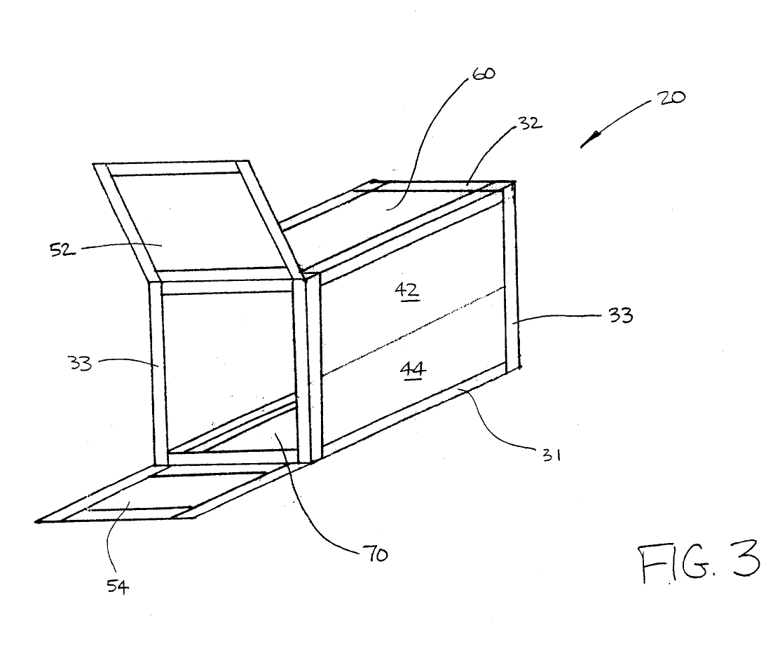

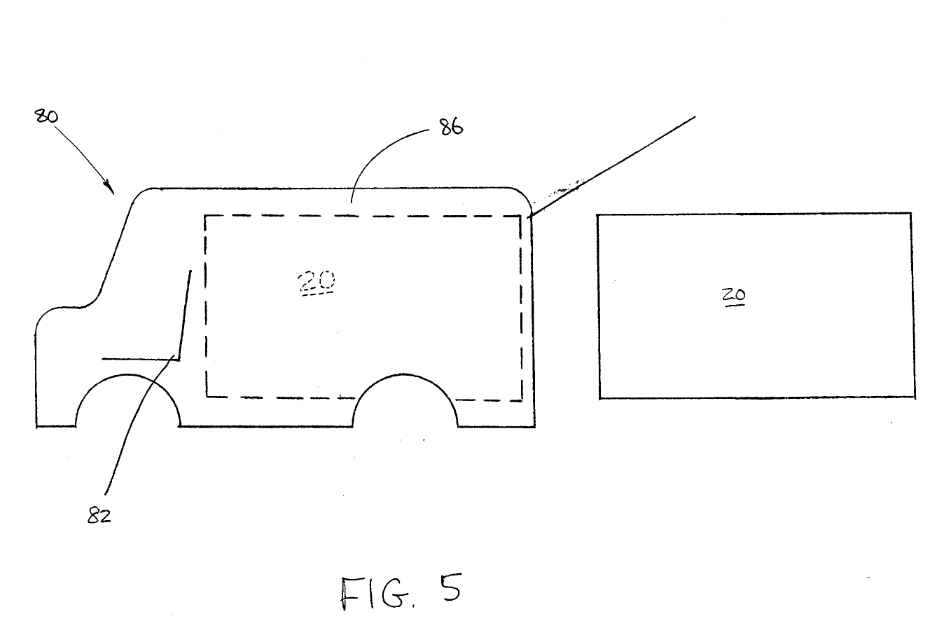

One or more of the side or end panels 40, 50 may be opened to facilitate the loading and unloading of the liner 20. FIG. 3 shows the opening of upper end panel 52 and lower end panel 54 for this purpose. With the liner 20 positioned in a vehicle (see the liner 20 shown in dotted lines in FIG. 5), the open panels 52, 54 may serve to protect the top and bottom edges, or jambs, of the vehicle's hatchway/doorway. Additionally, panels or flaps (not shown in the Figures) attached to the vertical support members 33 positioned at either side of the liner's opening may be provided to open outward to protect the vertical edges/jambs of the vehicle's hatchway/doorway. The panels 52, 54 (and the panels/flaps not shown in the Figures) may incorporate integral magnets, or the like for temporary, detachable attachment to the vehicle to create a seal preventing the ingress of cargo-related particulate matter to the vehicle's interior during the loading/unloading process.

The following steps represent a typical method for erecting the first embodiment of the protective liner from a fully collapsed condition. The first step is the establishment of the desired length for each of the support members 31, 32, 33. This is accomplished by loosening the locking device 34, that has been holding the support member 31, 32, 33 in its fully collapsed condition (i.e. its shortest overall length wherein one end is completely nested, or retracted, into the second end), extending the support member 31, 32, 33 to the desired length, and then tightening the locking device 34. In a typical configuration, each set of support members are adjusted to the same length (e.g. all of the long horizontal support members 31 are adjusted to length “A”, all of the short horizontal support members 32 are adjusted to length “B”, and all of the vertical support members 33 are adjusted to length “C”).

The second step is the establishment of the connections between the ends of the support members 31, 32, 33. Specifically, each end of a long horizontal support member 31 is attached, typically at a right angle, to an end of a vertical support member 33. The two planar assemblies created by the attachment of the long horizontal support members 31 to the vertical support members 33 are then connected, to form the completed box-like configuration of the protective liner 20, by attaching each end of a short horizontal support member 32, again typically at a right angle, to an end of a vertical support member 33.

The final step is the adjustment of the panels 40, 50, 60, 70 to enclose the volume established by the connections between the support members 31, 32, 33. The side, top, and bottom panels 40, 60, 70, respectively, are adjusted to match the established lengths of the long horizontal support members 31 and the vertical support members 33. Simultaneously, the end, top, and bottom panels 50, 60, 70, respectively, are adjusted to match the established lengths of the short horizontal support members 32 and the vertical support members 33. Each of the panels 40, 50, 60, 70 may be equipped with, for example, VELCRO® closures along each edge for detachable connection to a matching closure on an adjoining panel to complete the erect, sealed configuration of the protective liner 20.

To return the protective liner 20 to its fully collapsed state, the sequence outlined above is simply reversed.

Alternative embodiments of the present invention incorporate means to lower the side, end, and top panels 40, 50, 60, respectively, once the loading of the liner 20 is complete. Lowering the upper portion of the liner 20, such that the top panel 60 rests on the top surface of the cargo contained within, serves to prevent the cargo from shifting during transportation and, to the extent afforded by the height of the top surface of the cargo, removes the liner 20 from the vehicle operator's field of view.

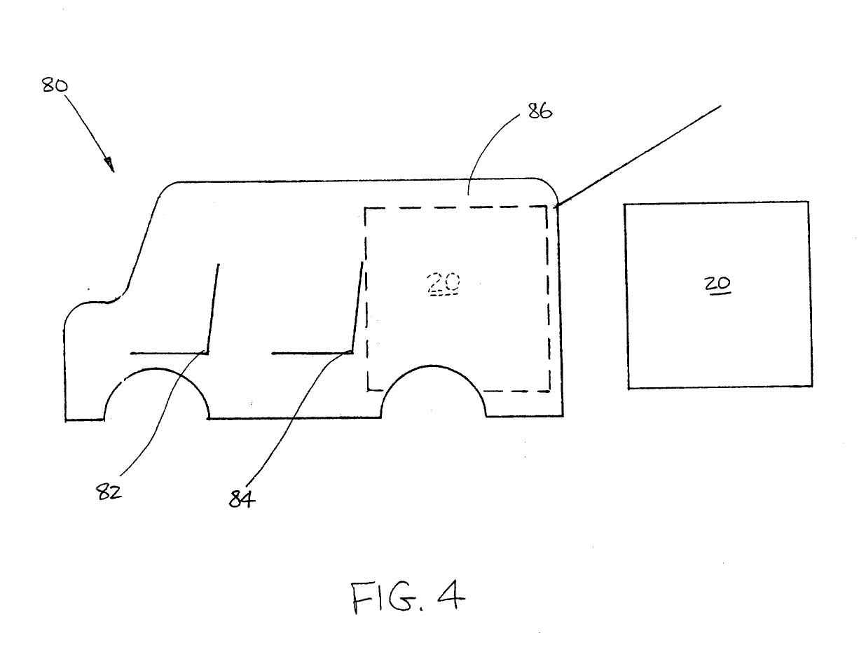

With reference to FIGS. 4 and 5, the dimensions and resulting volume of the liner 20 may be varied to suit a wide range of vehicle applications and configurations. A typical minivan is equipped with removable seats to allow users to significantly vary the configuration of its interior compartment. With all seating surfaces installed, the minivan maximizes its utility with respect to the transportation of people. With all but the front two seats removed, its utility with respect to hauling cargo is maximized. Most minivans also provide some sort of intermediate configuration providing for the transportation of up to four people along with a reasonable volume of cargo. FIG. 4 generally shows just such a vehicle 80 set up in the aforementioned intermediate configuration.

The intermediate configuration provides a front row 82 of seats, a second seating surface 84 (i.e. either two individual seats, as in the front row, or bench-style seating), and a moderately sized cargo compartment 86. The dimensions of the liner 20 are matched to the available cargo compartment by adjusting the lengths of the support members 31, 32, 33 (see FIG. 3). Once the panels 40, 50, 60, 70 (see FIGS. 1-3) are expanded/contracted to match the support members 31, 32, 33 (and the liner 20 is appropriately positioned within the vehicle), the loading process may commence.

In FIG. 5, the vehicle 80 is configured to maximize its utility with respect to hauling cargo (i.e. the second seating surface 84 shown in FIG. 4 is not present). Only the front row 82 of seats is present. The configuration provides the largest possible interior cargo compartment 86. Accordingly, the dimensions of the support members 31, 32, 33 and the associated panels 40, 50, 60, 70 may be adjusted to suit the larger cargo compartment. The protective liner 20 may be supplied in a variety of standardized dimensions, or volumes to accommodate interior configurations of a variety of standard vehicle types. Alternatively, the protective liner 20 can be custom manufactured with specific dimensions (i.e. the dimensions can be expanded or contracted) for specific vehicles.

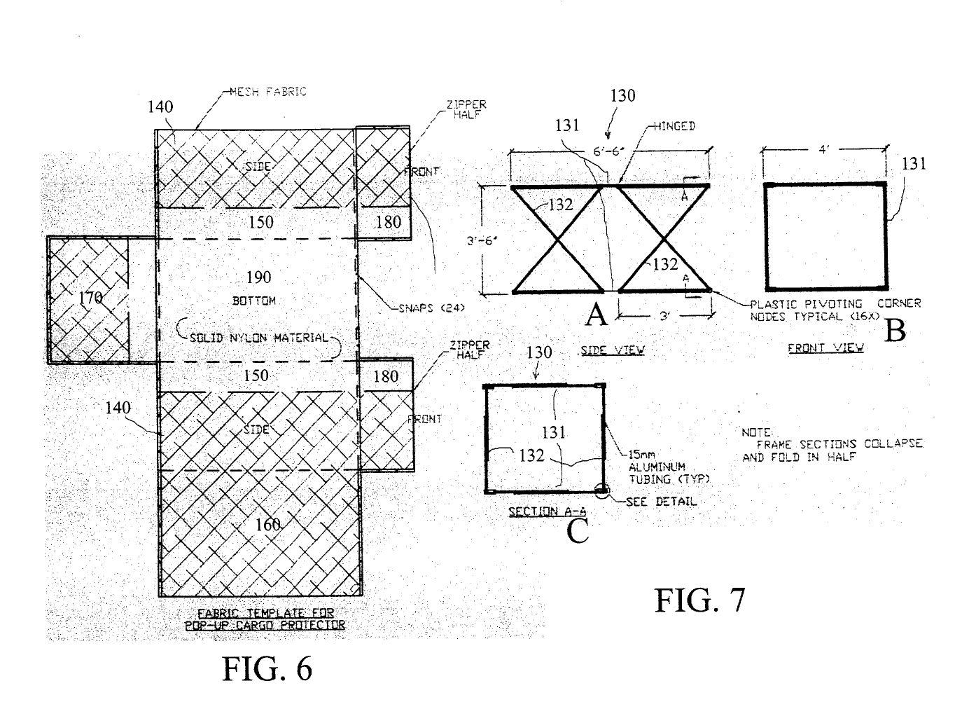

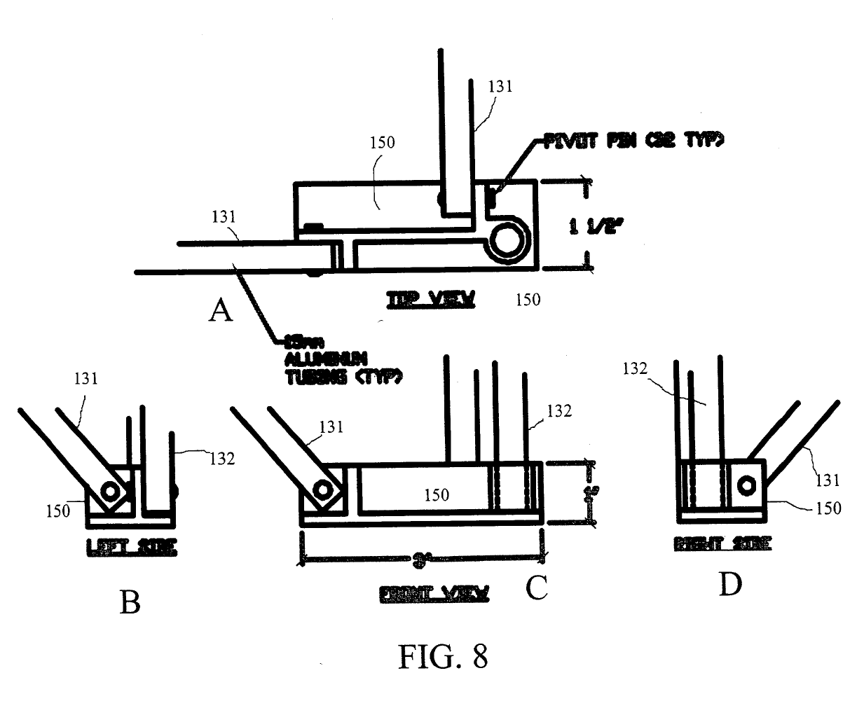

As shown in FIGS. 6 and 7, another embodiment of the collapsible cargo compartment protective liner 120 comprises a unitary fabric shell (shown in FIG. 6) including integral flexible side panels 140 formed of mesh fabric, flexible end panels 150 and a bottom panel 190 all formed of solid Nylon fabric, a flexible top panel 160 of solid Nylon fabric, a flexible back panel 170 of solid Nylon fabric, and opposing front panels 180 formed partly of mesh fabric and partly of solid Nylon fabric as shown. All panels are sewn together in a unitary configuration. A plurality of snap fasteners 24 are spaced about the bottom panel 190 and front panels 180 to allow secure closure of the latter. The fabric shell folds about a frame 130 as shown in FIG. 7. FIG. 7A illustrates the assembled frame 130, which includes a pair of upper and lower horizontal support members 131 and scissors-configured support members 132. FIG. 7B is a front view of the horizontal support members 131 which incorporate the telescoping design, as discussed above, for the purpose of adjusting the length of the present invention. The scissors-configured support members 132 incorporate interlocking hinges (discussed below with regard to FIG. 8) which couple to the horizontal support members 131. Each scissors-configured support member 131 comprises a pair of rigid support members pivoted together at their mid-sections. FIG. 7C is a cross-section taken along the lines A-A of FIG. 7A which illustrates the adjustable operation of the frame 130. Varying the position (i.e. the degree to which they are opened or closed) of the scissors-configured support members 132 serves to establish the width and height of protective liner 120. Varying the telescoping extent of the horizontal support members 131 adjusts the length of the protective liner 20. As stated above with regard to liner 20, each of the telescoping horizontal support members 131 may include a locking device to maintain a selected length. In addition, each of the telescoping support members 131 may be spring-loaded to automatically extend to a maximum allowable dimension defined by an internal dimension of a cargo compartment in which said protective liner is installed. The frame 130 may also be configured to fold in half once reduced to its fully collapsed state to further minimize the overall size of the present invention for storage.

FIG. 8 is a composite drawing of a top view (at position A), left side view (at position B), front view (at position C), and right side view (at position D) of an exemplary interlocking hinge of the scissors-configured support members 132 as in FIG. 7. Each interlocking hinge comprises a bracket 150 with integrally formed receptacle for insertion of an end of a corresponding horizontal support member 131. The scissors-configured support members 132 are pivotally attached at each bracket 150 by pivot pins as shown, and thereby pivotally couple the scissors-configured support members 132 to the inserted horizontal support members 131.

As is readily perceived in the foregoing description, the design of the protective liners 20, 120 are simple and straightforward, and may be economically manufactured. The flexible design (i.e. dimensions/volume, configuration) of the liners 20, 120 allow for a myriad of uses in the transportation of various types and amounts of cargo. The protective liners 20, 120 may be set up within the vehicle 80, or it may be erected outside of the vehicle 80 prior to its installation within the interior compartment. In its collapsed form, the liners 20, 120 measure approximately 48″×12″×12″ providing for easy storage.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A collapsible cargo compartment protective liner for protecting an interior compartment of a vehicle in which it is installed, comprising:
a collapsible frame; and
a plurality of flexible panel sections, each of said plurality of flexible panel sections being attached to said frame;
wherein said frame with said plurality of attached flexible panel sections takes the form of a three-dimensional, self-supporting assembly fully enclosing a volume for isolating cargo contained therein from the interior compartment of the vehicle in which it is installed.

2. The collapsible cargo compartment protective liner according to claim 1 wherein said frame comprises a plurality of rigid support members.

3. The collapsible cargo compartment protective liner according to claim 2 wherein each of said plurality of rigid support members is telescoping for length adjustment.

4. The collapsible cargo compartment protective liner according to claim 3, wherein each of said telescoping support members includes a locking device to maintain a selected length.

5. The collapsible cargo compartment protective liner according to claim 3 wherein each of said telescoping support members is spring-loaded to automatically extend to a maximum allowable dimension defined by an internal dimension of a cargo compartment in which said protective liner is installed.

6. The collapsible cargo compartment protective liner according to claim 2 wherein each of said plurality of rigid support members is detachably attached at right angles to at least two other support members.

7. The collapsible cargo compartment protective liner according to claim 2 wherein each of said plurality of rigid support members is pivotally attached to at least two other support members;
whereby a right angle is formed at each hinged connection to setup and utilize said protective liner.

8. The collapsible cargo compartment protective liner according to claim 1 wherein each of said flexible panel sections is slidably attached to at least two of said plurality of rigid support members.

9. The collapsible cargo compartment protective liner according to claim 1 wherein each of said flexible panel sections is removably attached to at least two of said plurality of rigid support members.

10. The collapsible cargo compartment protective liner according to claim 1 wherein at least one of said plurality of flexible panel sections is partially opaque and partially transparent.

11. The collapsible cargo compartment protective liner according to claim 10 wherein said transparent part of said at least one flexible panel section is fabricated of a lightweight open mesh material.

12. The collapsible cargo compartment protective liner according to claim 1 wherein each of said plurality of flexible panel sections is fabricated of a material possessing some amount of elasticity.

13. A collapsible cargo compartment protective liner for protecting an interior compartment of a vehicle in which it is installed, comprising:
a unitary fabric shell; and
a folding frame inserted into said shell, said frame including a pair of upper and lower horizontal support members, and a pair of scissors-configured side support members;
wherein said frame with said installed fabric shell takes a form of a three-dimensional, self-supporting assembly fully enclosing a volume for isolating cargo contained therein from the interior compartment of the vehicle in which it is installed.

14. The collapsible cargo compartment protective liner for protecting an interior compartment of a vehicle according to claim 13, wherein said unitary fabric shell further comprises two integral flexible side panels formed of mesh fabric, two flexible end panels and a bottom panel formed of solid fabric, a flexible top panel and a back panel both formed of solid fabric, and a pair of opposing front panels formed partly of mesh fabric and partly of solid fabric, all of said panels being sewn together in a unitary configuration.

15. The collapsible cargo compartment protective liner for protecting an interior compartment of a vehicle according to claim 13, wherein said scissors-configured support members are coupled to the horizontal support members at interlocking hinges.

16. The collapsible cargo compartment protective liner for protecting an interior compartment of a vehicle according to claim 15, wherein said scissors-configured support members each comprise a pair of rigid support members pivoted together at their mid-sections.

17. The collapsible cargo compartment protective liner according to claim 13 wherein each of said horizontal support members is telescoping for length adjustment.

18. The collapsible cargo compartment protective liner according to claim 17, wherein each of said telescoping support members includes a locking device to maintain a selected length.

19. The collapsible cargo compartment protective liner according to claim 18 wherein each of said telescoping horizontal support members is spring-loaded to automatically extend to a maximum allowable dimension defined by an internal dimension of a cargo compartment in which said protective liner is installed.
